(19) United States
(12) Patent Application Publication
(10) Pub. No.: US 2025/0180826 A1
(43) Pub. Date: Jun. 5, 2025

(54) Optical Fiber Pinching Prevention Features for VSFF Fiber Optic Connector Housing

(71) Applicant: US Conec Ltd., Hickory, NC (US)

(72) Inventor: Jason Higley, Hickory, NC (US)

(21) Appl. No.: 18/962,183

(22) Filed: Nov. 27, 2024

Related U.S. Application Data
(60) Provisional application No. 63/605,699, filed on Dec. 4, 2023.

(51) Int. Cl. G02B 6/38

(52) U.S. Cl. CPC G02B 6/3857

(57) ABSTRACT

A VSFF fiber optic connector has a housing with a first crimp half at a rear portion of the housing and having a fiber channel to receive optical fibers for termination in the VSFF fiber optic connector and a second crimp half separable from the first crimp half, the second crimp half being attachable to the housing at the first crimp half after termination of the optical fibers in the VSFF fiber optic connector. The first crimp half has first and second retention features to engage the second crimp half, wherein an inward facing surface of each of the first and the second retention features are continuous with the fiber channel.

### REFERENCE TO RELATED CASE

This application claims priority under 35 U.S.C. § 119 (e) to U.S. provisional application No. 63/605,699 filed on Dec. 4, 2023, the contents of which are hereby incorporated by reference in their entirety.

### BACKGROUND OF THE INVENTION

The body or housing of a very small form factor (“VSFF”) fiber optic connector (or “connector”) has a two-piece crimp area in the back to accommodate larger diameter fiber optic cables. These two pieces have a parting shelf that results from the separation of the two pieces. The parting shelf is a flat surface above and adjacent a fiber channel, where the optical fibers are positioned in a fiber channel. A part of the flat surface of the parting shelf is between retention features and the fiber channel. The retention features on the connector body half engage receiving recess on the crimp half that aids in securing the two pieces when assembled. The two crimp pieces combine after termination to form the crimp body of the VSFF connector. Due to the nature of optical fibers having the tendency to be straight, it is difficult to introduce bends for routing through the connector. The parting shelf acts as a pinch point when the two crimp pieces are brought together to assemble the VSFF fiber optic connector. Optical fibers would tend to rest on the parting shelf as a result of their nature to be straight. If the optical fibers were caught between the two halves when joining the two connector halves, the optical fibers could be pinched between the two halves at these two surfaces of the parting shelf. This may lead to damage or excessive bending of the pinched optical fibers leading to poor optical performance of the VSFF connector.

Applicant has provided a VSFF fiber optic connector that prevents the optical fibers from remaining outside the fiber channel through the VSFF fiber optic connector and causing damage to the VSFF fiber optic connector or deteriorating the signal passing therethrough.

### SUMMARY OF THE INVENTION

According to one aspect, the present invention is directed to a VSFF fiber optic connector that includes a housing having a first crimp half at a rear portion of the housing and having a fiber channel to receive optical fibers for termination in the VSFF fiber optic connector, and a second crimp half separable from the first crimp half, the second crimp half being attachable to the housing at the first crimp half after termination of the optical fibers in the VSFF fiber optic connector, wherein the first crimp half has a first retention feature and a second retention feature to engage the second crimp half, the second retention feature located across from the fiber channel relative to the first retention feature, and wherein an inward facing surface of each of the first retention feature and the second retention feature are continuous with the fiber channel, the fiber channel being wider adjacent the first retention feature and the second retention feature than rearward of the first retention feature and the second retention feature.

In some embodiments, the second crimp half has a pair of receiving features to respectively receive the first retention feature and the second retention feature for a final assembly of the VSFF fiber optic connector, wherein upon the final assembly of the VSFF connector, there are no optical fibers outside of the fiber channel between the first crimp half and the second crimp half.

In some embodiments, the first crimp half and the second crimp half form a crimp body upon being attached to one another.

In some embodiments, the first retention feature and the second retention feature have different configurations and sizes mating features rearward of the retention features.

In another embodiment, the first crimp half has a first parting shelf and second crimp half has a second parting shelf and the second crimp half being attached to the first crimp half along the first parting shelf and the second parting shelf.

In yet another embodiment, the first parting shelf and the second parting shelf have no surface between the fiber channel and the first and second retention features that is parallel to a longitudinal plane between two short sides of the housing.

In some embodiments, at least one of the first retention feature and the second retention feature of the first crimp half is a projection to engage at least one depression in the second crimp half.

In some embodiments, the second crimp half has at least one projection to engage at least one depression in the first crimp half.

In some embodiments, the first retention feature and the second retention feature are longer than tall.

In yet another aspect, there is a VSFF fiber optic connector that includes a housing having a first crimp half at a rear portion of the housing and having a fiber channel to receive optical fibers for termination in the VSFF fiber optic connector, the first crimp half having a first parting shelf, the housing having a second crimp half separable from the first crimp half, the second crimp half having a second parting shelf, the second crimp half being attached to the first crimp half along the first parting shelf and the second parting shelf after termination of the optical fibers in the VSFF fiber optic connector, the first crimp half has a first retention feature and a second retention feature, the second retention feature located across from the fiber channel relative to the first retention feature, and the first parting shelf and the second parting shelf have no surface between the fiber channel and the first and second retention features that is parallel to a longitudinal plane between two short sides of the housing.

In some embodiments, the second crimp half has a pair of receiving features to respectively receive the first retention feature and the second retention feature for a final assembly of the VSFF fiber optic connector, wherein upon the final assembly of the VSFF connector, there are no optical fibers outside of the fiber channel between the first crimp half and the second crimp half.

In some embodiments, the first crimp half and the second crimp half form a crimp body upon being attached to one another.

In some embodiments, the first retention feature and the second retention feature have different configurations and sizes from mating features rearward of the retention features.

In another embodiment, the first crimp half has a first parting shelf and a second crimp half has a second parting shelf and the second crimp half being attached to the first crimp half along the first parting shelf and the second parting shelf.

In yet another embodiment, the first parting shelf and the second parting shelf have no surface between the fiber channel and the first and second retention features that is parallel to a longitudinal plane between two short sides of the housing.

In some embodiments, at least one of the first retention feature and the second retention feature of the first crimp half is a projection to engage at least one depression in the second crimp half.

In some embodiments, the second crimp half has at least one projection to engage at least one depression in the first crimp half.

In some embodiments, the first retention feature and the second retention feature are longer than tall.

In yet another aspect, there is a VSFF fiber optic connector that includes a housing having a first crimp half at a rear portion of the housing and having a fiber channel to receive optical fibers for termination in the VSFF fiber optic connector and a second crimp half separable from the first crimp half, the second crimp half being attachable to the housing at the first crimp half after termination of the optical fibers in the VSFF fiber optic connector, the first crimp half has a first retention feature and a second retention feature to engage the second crimp half, the second retention feature located across from the fiber channel relative to the first retention feature, and an inward facing surface of each of the first retention feature and the second retention feature is flush with the fiber channel such that the inward facing surface and the fiber channel form a continuous smooth surface, the fiber channel being wider adjacent the first retention feature and the second retention feature than rearward of the first retention feature and the second retention feature.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a perspective view of a prior art VSFF fiber optic connector;

FIG. 2 is a perspective, exploded view of the prior art VSFF fiber optic connector in FIG. 1;

FIG. 3 is an elevational view of the connector body half of the prior art VSFF fiber optic connector in FIG. 1;

FIG. 4 is a top view of the connector body half of the prior art VSFF fiber optic connector in FIG. 1;

FIG. 5 is a perspective view of one embodiment of a housing of a VSFF fiber optic connector according to the present invention;

FIG. 6 is a side elevational view of both halves of the VSFF fiber optic connector in FIG. 5 at the crimp halves;

FIG. 7 is a perspective view of the connector body half of the prior art VSFF fiber optic connector in FIG. 1;

FIG. 8 is a perspective view of the housing with the first crimp half of the VSFF fiber optic connector in FIG. 5;

FIG. 9 is a perspective view of the second half of the VSFF fiber optic connector in FIG. 5 and mates with the first crimp half of the VSFF fiber optic connector in FIG. 5;

FIG. 10 is an elevational view of the housing along the line 10-10 in FIG. 8;

FIG. 11 is a top view of the connector body half of the VSFF fiber optic connector in FIG. 5;

FIG. 12 is a side perspective view of the of the housing of the VSFF fiber optic connector in FIG. 5;

FIG. 13 is a perspective view of another embodiment of a housing of a VSFF fiber optic connector according to the present invention; and

FIG. 14 is a perspective view of a third embodiment of a connector body half of a VSFF fiber optic connector according to the present invention.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

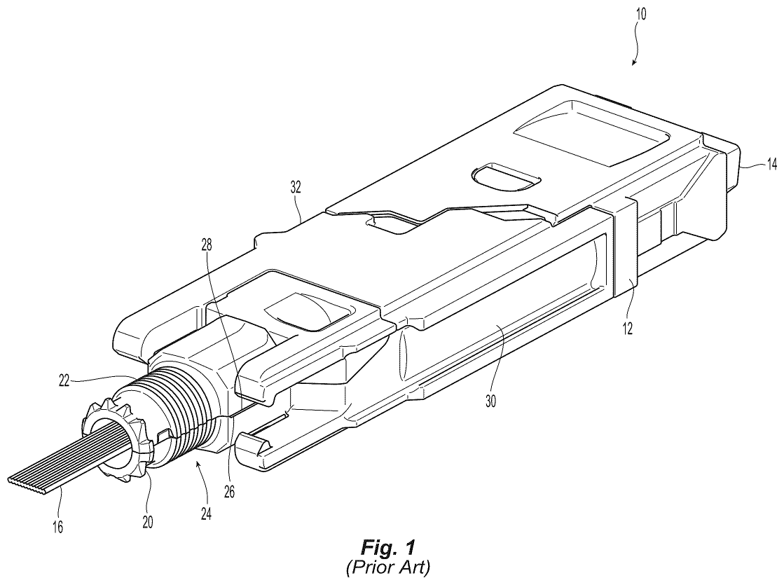

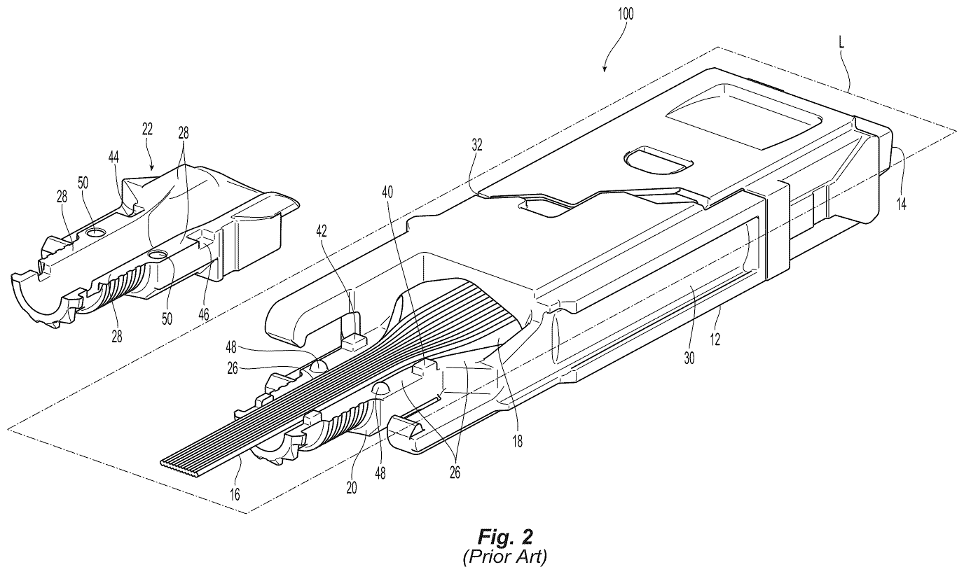

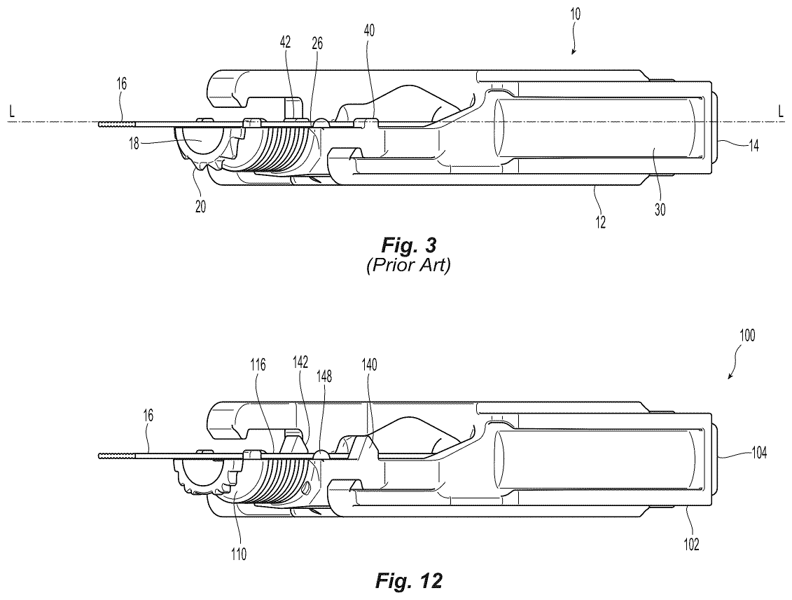

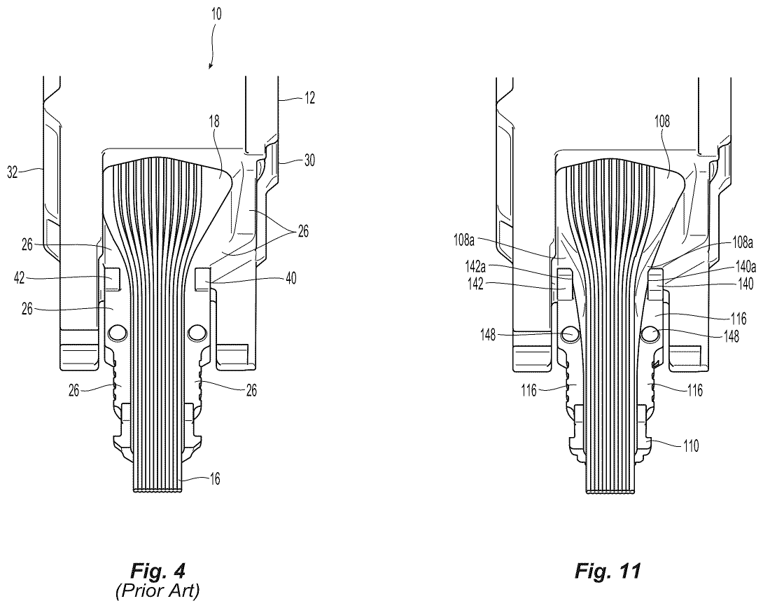

Illustrated in FIGS. 1-4 is one embodiment of a prior art VSFF fiber optic connector 10. The VSFF fiber optic connector 10 has a housing 12, a fiber optic ferrule 14, optical fibers 16 that are disposed within a fiber channel 18, and a first crimp half 20 at the rear end of the VSFF fiber optic connector 10. There is a second crimp half 22 that is attached to the first crimp half 20 that, together, form a crimp body 24 for the VSFF fiber optic connector 10. The two crimp halves 20,22 join along parting shelves 26,28. There is one parting shelf 26,28 on each side of the fiber channel 18 of each of the crimp halves 20,22. See FIGS. 2 and 3. See also FIG. 4. The term “parting shelf” as used herein generally refers to a ledge adjacent the fiber channel 18 on each of the crimp halves 20,22 formed as a result of the molding thereof and is generally a flat surface. Further, the term “crimp halves” does not imply that the two pieces are exactly of same configuration, and the relative sizes are appreciated from the drawings by one of ordinary skill in the art. In the VSFF fiber optic connector 10, the parting shelves 26,28 are in a longitudinal plane L, that extends between two short sides 30,32 of the housing 12. As can be seen, particularly in FIGS. 2 and 4, the parting shelves 26,28 being flat, may provide a surface for the optical fibers 16 to rest. See FIG. 4. When the second crimp half 22 is attached to the first crimp half 20, one or more of the optical fibers 16 could be pinched between the first crimp half 20 and the second crimp half 22, possibly affecting the signal passing through the optical fibers 16 or damaging the optical fibers 16 themselves. Although the optical fibers 16 shown herein are in a ribbon form, this issue may occur with loose optical fibers 16 too. On the parting shelves 26 there are two retention features 40,42 to assist in attaching the first crimp half 20 and the second crimp half 22. The two retention features 40,42 are illustrated as being projections extending upward off the parting shelves 26 and are opposite sides of the fiber channel 18. It should be noted that the fiber channel 18 is wider at the retention features 40,42 (and forward thereof) than rearward thereof. See FIG. 4. The wider portion of the fiber channel 18 allows for the fibers to smoothly transition to an appropriate pitch for termination in one or more fiber optic ferrules of the VSFF fiber optic connector 10.

There are also receptacles or receiving features 44,46 to receive the retention features 40,42 on the parting shelves 28 when joined together. The retention features 40,42 could also be switched with the receiving features 44,46 on the parting shelves 26,28. The retention features 40,42 also assist in keeping the optical fibers 16 within the fiber channel 18 by being a barrier for the optical fibers 16. However, it is clear that the optical fibers 16 may still be resting on the parting shelves 26 since there is room on the parting shelves 26 between the fiber channel 18 and the retention features 40,42 for the optical fibers 16 to stray from the fiber channel 18.

The parting shelves 26,28, may also have other/additional mating features 48,50 to help keep the first crimp half 20 and the second crimp half 22 together. The mating features 48 on the first crimp half 20 are a projection from the parting shelves 26. The mating feature 48 is preferably rounded, but could take on any number of configurations and sizes. It is preferable that mating feature 48 is smaller than that of retention feature 40. The parting shelves 28 each has the complementary mating feature 50 which in this case is a depression that receives mating feature 48. The mating features 48,50 could be reversed and be on opposite crimp halves 20,22. The mating features 48,50 are preferably more rearward than the two retention features 40,42.

There may be other components in the VSFF fiber optic connector 10 that are not discussed herein, but are known to one of ordinary skill in the art-such as springs, guide pins, spacers, etc. However, those known elements will not be described herein.

Applicant notes that the term “front” or “forward” means that direction where the fiber optic ferrule would meet with another fiber optic ferrule or device, while the term “rear” or “rearward” is used to mean the direction from which the optical fibers enter into the fiber-optic ferrule or fiber optic connector. In the present application, the VSFF fiber optic connector 10 (and the VSFF fiber optic connector 100) will therefore have a front and a rear, the front will be where the fiber optic ferrule 14 is located. Thus, in FIG. 1, the “front” of the VSFF fiber optic connector is on the right side of the figure and pointing into the page. The “rear” or “back” is that part of the VSFF fiber optic connector 10 that is on the left side of the page and “rearward” and “backward” is toward the left and out the page.

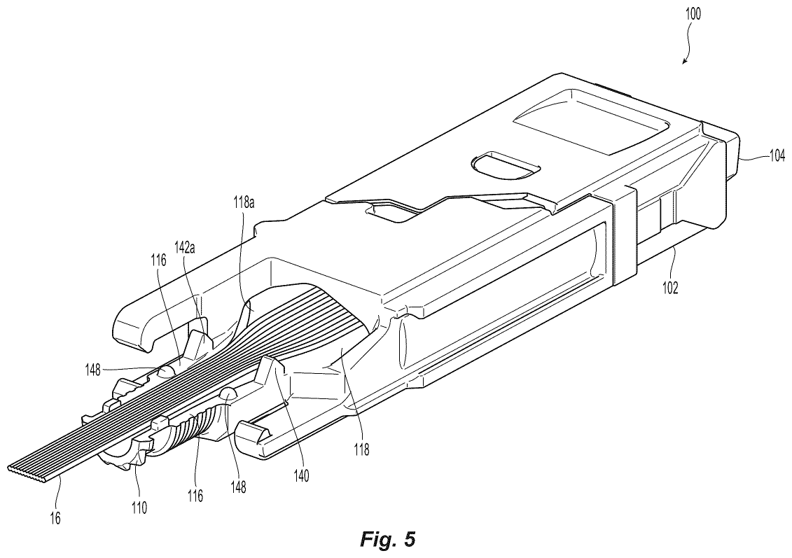

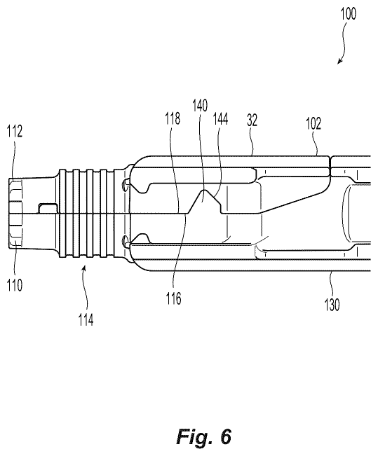

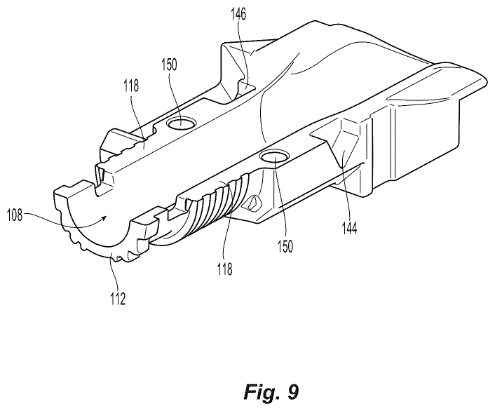

Turning now to FIGS. 5-6, and 8-11, there is one embodiment of a VSFF fiber optic connector 100 according to the present invention. The VSFF fiber optic connector 100 has a housing 102, a fiber optic ferrule 104, optical fibers 106 that are disposed within a fiber channel 108, and a first crimp half 110 at the rear end of the VSFF fiber optic connector 100. There is a second crimp half 112 that is attached to the first crimp half 110 that, together, form a crimp body 114 for the VSFF fiber optic connector 100. See FIG. 9. The two crimp halves 110,112 join along parting shelves 116,118. See FIG. 6. There is one parting shelf 116,118 on each side of each of the crimp halves 110,112. See FIGS. 6, 8, 9, and 11. The VSFF fiber optic connector 100 may also have other components that are not discussed herein, but are known to one of ordinary skill in the art—such as springs, guide pins, spacers, etc. These components do not necessarily affect the composition of or the working of the present invention.

On the parting shelves 116 there are two retention features 140,142 to assist in attaching the first crimp half 110 and the second crimp half 112. The two retention features 140,142 are illustrated as being projections extending upward off the parting shelves 116 and are opposite sides of the fiber channel 108. That is, the second retention 142 feature is located across from the fiber channel 108 relative to the first retention feature 140. As with the prior art, the retention features 140, 142 also assist in keeping the optical fibers 16 within the fiber channel 108 by acting as a barrier for the optical fibers 16. It should be noted that the fiber channel 108 is wider at the retention features 140,142 (and forward thereof) than rearward thereof. See FIG. 11.

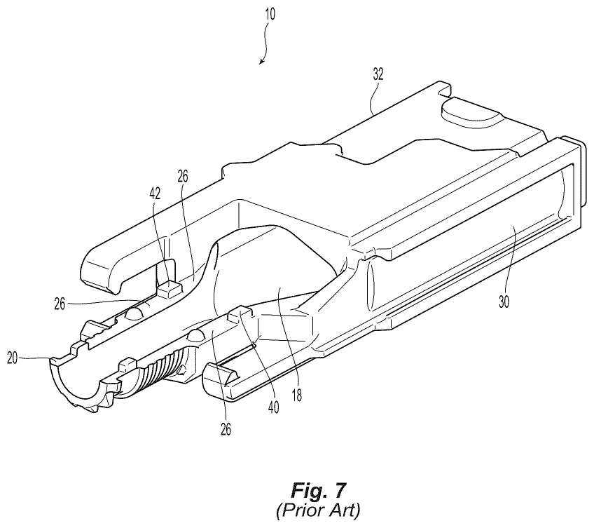

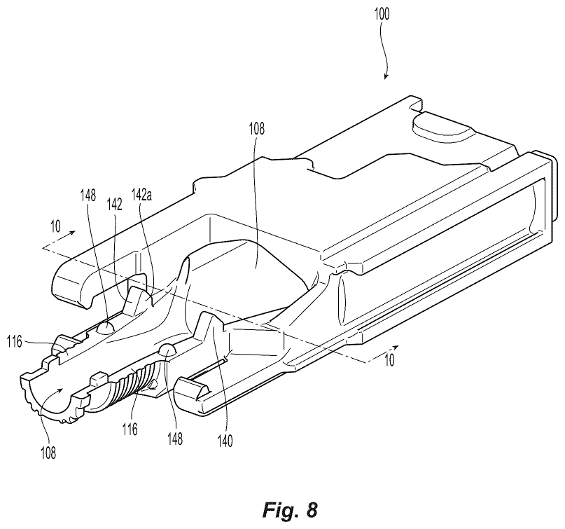

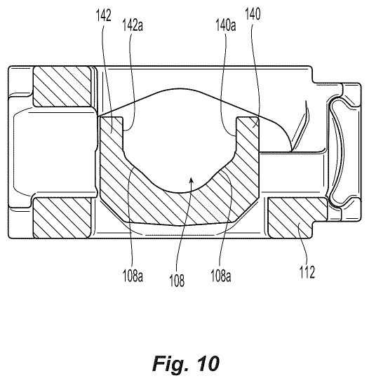

The retention features 140,142 are generally larger and extend farther away from the parting shelves 116 than in the prior art retention features 40,42 (e.g. higher). Cf. FIGS. 3 and 12. Each of the retention features 140,142 respectively have an interior surface 140a,142a (or, an inward facing surface 140a,142a) that is continuous with, or flush with, the surface 108a of the fiber channel 108 as best shown in FIG. 10. These inward facing surfaces 140a, 142a form a continuous smooth surface with the fiber channel 108. This eliminates the part of the parting shelves 26 of the prior art that were flat between the retention features 140,142 and the fiber channel 18 and thus reduces or eliminates the possibility of the optical fibers 16 being caught between the two crimp halves 110,112 when they are attached to one another. A keen eye will also notice that at the retention features 140,142, the parting shelves 116 have no flat surfaces. See FIGS. 8-11. Thus, parting shelves 116 have no surface between the fiber channel 108 and the first and second retention features 140,142 that is parallel to a longitudinal plane L between two short sides of the housing of the VSFF fiber optic connector 100. Rather, the inward facing surfaces 140a,142a join smoothly without a discontinuity with the fiber channel 108. Whatever flat surface then exists is forward of the retention features 140,142 where the fiber channel 108 is wider than at the retention features 140,142. As a result, upon the final assembly of the VSFF connector 100, there are no optical fibers 16 outside of the fiber channel 108 between the first crimp half 110 and the second crimp half 112. This is because the elimination of the flat surfaces at the retention features 140,142 removes any place for one or more of the optical fibers 16 to rest upon and get pinched subsequently during assembly of the VSFF connector 100.

There are also receptacles or receiving features 144,146 to receive the retention features 140,142 on the parting shelves 118 when joined together. There may be, for example, a pair of such receiving features 144,146. The retention features 140,142 could also be switched with the receiving features 144,146 on the parting shelves 116. In addition to the retention features 140,142 keeping the optical fibers 16 within the fiber channel 108, they strengthen the attachment of the two crimp halves 110,112 due to their size and configuration.

The parting shelves 116,118, may also have other/additional mating features 148,150 to help keep the first crimp half 110 and the second crimp half 112 together. The mating features 148 on the first crimp half 110 are a projection from the parting shelves 116. The mating features 148 are preferably rounded, but could take on any number of configurations and sizes. It is preferable that mating features 148 are smaller than that of retention feature 140. The parting shelves 118 each have the complementary mating features 150, which in this case are depressions that receive mating features 148. The mating features 150 may also have the same or different configuration than the mating features 148. The mating features 148,150 could be reversed and be on opposite crimp halves 110,112. The mating features 148,150 are also preferably more rearward on the housing 102 than the two retention features 140,142. Thus, when the first crimp half 110 and the second crimp half 112 are joined, the fiber channel 108 fully contains the optical fibers 16 and there is no optical fiber present outside of the fiber channel 108 that is trapped between the first crimp half 110 and the second crimp half 112.

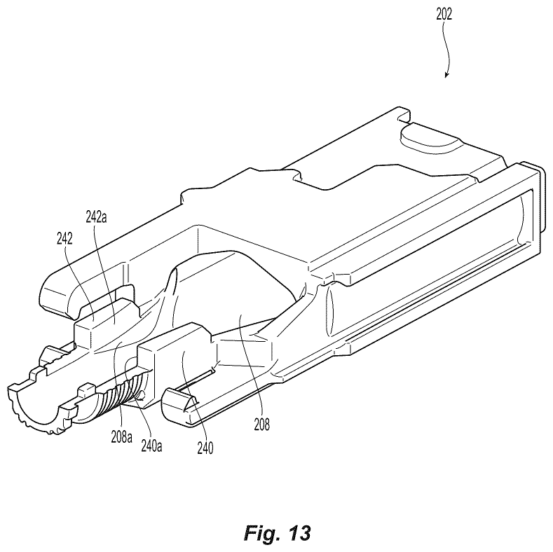

Another embodiment of a VSFF connector housing 202 is illustrated in FIG. 13. In this embodiment, the retention features 240,242 extend farther along the fiber channel 208 than the previous embodiments. The retention features 240,242 have the same inner surfaces 240a,242a that is continuous with the surface 208a of the fiber channel 208 and are positioned so that there is no surface for the optical fibers (not shown) to rest on outside the fiber channel 208. The first retention feature 240 and the second retention feature 242 are each longer than tall.

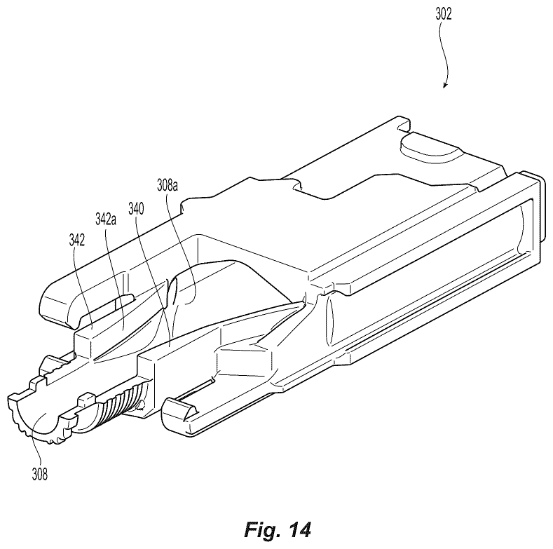

Another embodiment of a VSFF connector housing 302 is illustrated in FIG. 14. In this embodiment, the retention features 340,342 extend farther along the fiber channel 308 than the previous embodiments and is tapered in a back to front direction. The retention features 340,342 have the same inner surfaces 340a,342a that is continuous with the surface 308a of the fiber channel 308 and are positioned so that there is no surface for the optical fibers (not shown) to rest on outside the fiber channel 308. The first retention feature 340 and the second retention feature 342 are each longer than tall.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A VSFF fiber optic connector comprising:
a housing having a first crimp half at a rear portion of the housing and having a fiber channel to receive optical fibers for termination in the VSFF fiber optic connector; and
a second crimp half separable from the first crimp half, the second crimp half being attachable to the housing at the first crimp half after termination of the optical fibers in the VSFF fiber optic connector,
wherein the first crimp half has a first retention feature and a second retention feature to engage the second crimp half, the second retention feature located across from the fiber channel relative to the first retention feature, and
wherein an inward facing surface of each of the first retention feature and the second retention feature are continuous with the fiber channel, the fiber channel being wider adjacent the first retention feature and the second retention feature than rearward of the first retention feature and the second retention feature.

2. The VSFF fiber optic connector according to claim 1, wherein the second crimp half has a pair of receiving features to respectively receive the first retention feature and the second retention feature for a final assembly of the VSFF fiber optic connector, wherein upon the final assembly of the VSFF fiber optic connector, there are no optical fibers outside of the fiber channel between the first crimp half and the second crimp half.

3. The VSFF fiber optic connector according to claim 1, wherein the first crimp half and the second crimp half form a crimp body upon being attached to one another.

4. The VSFF fiber optic connector according to claim 1, wherein the first retention feature and the second retention feature have different configurations and sizes from mating features rearward of the retention features.

5. The VSFF fiber optic connector according to claim 1, wherein the first crimp half has a first parting shelf and second crimp half has a second parting shelf and the second crimp half being attached to the first crimp half along the first parting shelf and the second parting shelf.

6. The VSFF fiber optic connector according to claim 5, wherein the first parting shelf and the second parting shelf have no surface between the fiber channel and the first and second retention features that is parallel to a longitudinal plane between two short sides of the housing.

7. The VSFF fiber optic connector according to claim 1, wherein at least one of the first retention feature and the second retention feature of the first crimp half is a projection to engage at least one depression in the second crimp half.

8. The VSFF fiber optic connector according to claim 1, wherein the second crimp half has at least one projection to engage at least one depression in the first crimp half.

9. The VSFF fiber optic connector according to claim 1, wherein the first retention feature and the second retention feature are longer than tall.

10. A VSFF fiber optic connector comprising:
a housing having a first crimp half at a rear portion of the housing and having a fiber channel to receive optical fibers for termination in the VSFF fiber optic connector, the first crimp half having a first parting shelf; and
the housing having a second crimp half separable from the first crimp half, the second crimp half having a second parting shelf, the second crimp half being attached to the first crimp half along the first parting shelf and the second parting shelf after termination of the optical fibers in the VSFF fiber optic connector, and
wherein the first crimp half has a first retention feature and a second retention feature, the second retention feature located across from the fiber channel relative to the first retention feature, and
wherein the first parting shelf and the second parting shelf have no surface between the fiber channel and the first and second retention features that is parallel to a longitudinal plane between two short sides of the housing.

11. The VSFF fiber optic connector according to claim 10, wherein the second crimp half has a pair of receiving features to respectively receive the first retention feature and the second retention feature for a final assembly of the VSFF fiber optic connector, wherein upon the final assembly of the VSFF connector, there are no optical fibers outside of the fiber channel between the first crimp half and the second crimp half.

12. The VSFF fiber optic connector according to claim 10, wherein the first crimp half and the second crimp half form a crimp body upon being attached to one another.

13. The VSFF fiber optic connector according to claim 10, wherein the first retention feature and the second retention feature have different configurations and sizes from mating features rearward of the retention features.

14. The VSFF fiber optic connector according to claim 10, wherein the first crimp half has a first parting shelf and second crimp half has a second parting shelf and the second crimp half being attached to the first crimp half along the first parting shelf and the second parting shelf.

15. The VSFF fiber optic connector according to claim 14, wherein the first parting shelf and the second parting shelf have no surface between the fiber channel and the first and second retention features that is parallel to a longitudinal plane between two short sides of the housing.

16. The VSFF fiber optic connector according to claim 10, wherein at least one of the first retention feature and the second retention feature of the first crimp half is a projection to engage at least one depression in the second crimp half.

17. The VSFF fiber optic connector according to claim 10, wherein the second crimp half has at least one projection to engage at least one depression in the first crimp half.

18. The VSFF fiber optic connector according to claim 10, wherein the first retention feature and the second retention feature are longer than tall.

19. A VSFF fiber optic connector comprising:
a housing having a first crimp half at a rear portion of the housing and having a fiber channel to receive optical fibers for termination in the VSFF fiber optic connector; and
a second crimp half separable from the first crimp half, the second crimp half being attachable to the housing at the first crimp half after termination of the optical fibers in the VSFF fiber optic connector,
wherein the first crimp half has a first retention feature and a second retention feature to engage the second crimp half, the second retention feature located across from the fiber channel relative to the first retention feature, and
wherein an inward facing surface of each of the first retention feature and the second retention feature is flush with the fiber channel such that the inward facing surface and the fiber channel form a continuous smooth surface, the fiber channel being wider adjacent the first retention feature and the second retention feature than rearward of the first retention feature and the second retention feature.

20. The VSFF fiber optic connector of claim 19, wherein when the first crimp half and the second crimp half are joined, the fiber channel fully contains the optical fibers and there is no optical fiber present outside of the fiber channel between the first crimp half and the second crimp half.
